(19) United States
(12) Patent Application Publication
(10) Pub. No.: US 2023/0198913 A1
(43) Pub. Date: Jun. 22, 2023

(54) ADAPTIVE PATENT PAYLOAD AGGREGATION

(71) Applicant: VMware, Inc., Palo Alto, CA (US)

(72) Inventors: Kumara Parameshwaran Rathnavel, Bangalore (IN); Raghav Kempanna, Bangalore (IN); Rajagopal Sreenivasan, Bangalore (IN); Sudarshana Kandachar Sridhara Rao, Bangalore (IN); Aravindhan K, Chennai (IN); Tathagat Priyadarshi, Bangalore (IN)

(21) Appl. No.: 18/081,660

(22) Filed: Dec. 14, 2022

(30) Foreign Application Priority Data
Dec. 16, 2021 (IN) 202141058813

(51) Int. Cl. H04L 47/43; H04L 47/36

(52) U.S. Cl. CPC H04L 47/43; H04L 47/36; H04L 47/125

(57) ABSTRACT

The method of some embodiments forwards packets to a destination node executing on a host computer. The method identifies a set of one or more attributes associated with a set of one or more packets of a data flow. Based on the identified set of attributes, the method dynamically specifies a set of parameters for aggregating, for the destination node, payloads of multiple groups of packets of the data flow. The method creates, according to the set of parameters, an aggregate packet for each group of packets and then forwards each aggregate packet to the destination node. In some embodiments, aggregating each group of packets includes setting headers for each aggregate packet, forwarded to the destination node, where the headers for each aggregate packet correspond to headers of the group of packets.

In modern networking, data packets sent through the Internet have a maximum transmission unit (MTU) size of 1500 bytes. This size was set when the data transmission rates of Internet capable devices were considerably lower than they are at present. At what is now a moderate speed of Ethernet data transmission (e.g., 1 GB/s), this relatively small MTU size results in a very large number of packets (on the order of 7 million packets per second) in a data transmission. Each packet generates a certain amount of overhead for any end destination application or middlebox (e.g., firewalls, packet encryption/decryption, etc.) application that processes the packets of a data flow. Increasing the size of packets sent on the Internet is not feasible as it would require upgrading the MTU for every possible intermediate router along a route.

One existing procedure for reducing the number of packets that the applications handle for a particular data flow is the generic receive offload (GRO) technique. In this technique, sequential data packets received within a fixed time window are aggregated (or coalesced) to aggregate data payloads of multiple packets, received in that time window, that have TCP/IP headers that are identical (with narrow exceptions known to those of ordinary skill in the art) to each other. The aggregate data is prepended with a header including the same source/destination address tuple, and other header values, as the original packets to generate a single, larger TCP/IP packet (e.g., 64 kB, etc.). However, in the existing art, a particular GRO layer applied to incoming packets only aggregates packets for a fixed time interval that applies to every data flow, regardless of the contents or nature of that flow. For example, an existing GRO layer may aggregate all packets of each flow that are received within 10 μs.

For different applications, the natures of different data flows vary. Some data flows, and in some cases particular sub-flows of a data flow, require low latency (e.g., flows involving two-way video or audio communications), other data flows are sent by applications that can handle longer latency and benefit from more packet consolidation (e.g., flows involving large file transfers). The one-size-fits-all approach of the existing GRO layer art does not adapt to the different requirements of the different types of data flows. In order to avoid a high latency that is deleterious to the operation of applications with data flows that require low latency, the time interval of the exiting GRO layers must be kept relatively low, but the relatively low time interval reduces the potential gains in efficiency from aggregating packets. Accordingly, there is a need in the art for an adaptive GRO that handles different flows according to their individual characteristics.

### BRIEF SUMMARY

The method of some embodiments forwards packets to a destination node executing on a host computer. The method identifies a set of one or more attributes associated with a set of one or more packets of a data flow. Based on the identified set of attributes, the method dynamically specifies a set of parameters for aggregating, for the destination node, payloads of multiple groups of packets of the data flow. The method creates, according to the set of parameters, an aggregate packet for each group of packets and then forwards each aggregate packet to the destination node. In some embodiments, aggregating each group of packets includes setting headers for each aggregate packet, forwarded to the destination node, where the headers for each aggregate packet correspond to headers of the group of packets.

The set of packets, in some embodiments, include packets that belong to a first sub-flow of the data flow. The first sub-flow includes packets of the flow differentiated from other sub-flows of the data flow by L7 parameters of the sub-flow. In some embodiments, the method further includes identifying a second set of one or more attributes of a second set of packets of the data flow, the second set of packets including a second sub-flow. Based on the identified second set of attributes, the method of some embodiments dynamically specifies a second set of parameters for aggregating, for the destination node, payloads of multiple groups of packets of the second sub-flow of the data flow, where the second set of parameters are different from the first set of parameters and then forwards an aggregate packet for each group of packets of the second sub-flow to the destination node. The packets of the first sub-flow and the packets of the second sub-flow have the same 5-tuple.

The method of some embodiments further includes determining that the first sub-flow includes a response to a particular data request, where the set of parameters for aggregating is based at least partly on a size of the requested data. The set of packets may include a content length identifier, in some embodiments. The method of such embodiments further includes identifying the size of the requested data based on the content length identifier. The particular data request is an HTTP get request and the method, in some embodiments further includes identifying the size of the requested data based on data payloads of an outgoing set of packets including at least one packet that includes the HTTP get request. The method of some embodiments further includes determining that the set of packets includes data packets associated with a particular application, where the set of parameters for aggregating is based at least partly on the particular application.

The identified set of attributes, in some embodiments, includes feedback of at least one of L3, L4, and L7 layers of the data flow. The feedback from the L3/L4 layers, in some embodiments, includes a window size of the data flow. The feedback from the L7 layers includes a URL of the data flow, in some embodiments. The set of parameters for aggregating packets of each group, in some embodiments, includes a minimum number of packets to aggregate in each group.

In some embodiments, the method further includes receiving a second set of packets, where the second set of packets includes a combined data payload size below a particular threshold. The method of such embodiments provides the second set of packets to a second destination node without aggregating the second set of packets. In some embodiments, the set of parameters for aggregating each group of packets includes an aggregation time limit for receiving a group of packets for aggregation.

The method of some embodiments described herein provide a dynamic/adaptive generic receive offload (GRO) operation that aggregates packets of different data flows and even groups of packets of the same data flows according to parameters that are adjusted to account for the nature of the flows/groups of packets. These dynamic/adaptive GRO operations ensure, among other advantages, that groups of packets for applications that are harmed by high latency do not overly delay the delivery of data by aggregating too many packets and that larger numbers of packets in groups of packets for applications that do not suffer from high latency are aggregated.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a datacenter of some embodiments.

FIG. 2 conceptually illustrates a process of some embodiments for receiving data packets at a GRO layer.

FIG. 3A conceptually illustrates the path of data packets and feedback through multiple protocol layers in the GRO system of some embodiments.

FIG. 3B conceptually illustrates a more detailed view of the operations of the GRO operation.

FIG. 4 illustrates the operations of the virtual distributed router to implement the GRO layer between the NIC and the machines of a host computer.

FIG. 5 illustrates a graphical user interface (GUI) for setting default GRO intervals.

FIG. 6 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

The method of some embodiments forwards packets to a destination node executing on a host computer. The method identifies a set of one or more attributes associated with a set of one or more packets of a data flow. Based on the identified set of attributes, the method dynamically specifies a set of parameters for aggregating, for the destination node, payloads of multiple groups of packets of the data flow. The method creates, according to the set of parameters, an aggregate packet for each group of packets and then forwards each aggregate packet to the destination node. In some embodiments, aggregating each group of packets includes setting headers for each aggregate packet, forwarded to the destination node, where the headers for each aggregate packet correspond to headers of the group of packets.

The set of packets, in some embodiments, include packets that belong to a first sub-flow of the data flow. The first sub-flow includes packets of the flow differentiated from other sub-flows of the data flow by L7 parameters of the sub-flow. In some embodiments, the method further includes identifying a second set of one or more attributes of a second set of packets of the data flow, the second set of packets including a second sub-flow. Based on the identified second set of attributes, the method of some embodiments dynamically specifies a second set of parameters for aggregating, for the destination node, payloads of multiple groups of packets of the second sub-flow of the data flow, where the second set of parameters are different from the first set of parameters and then forwards an aggregate packet for each group of packets of the second sub-flow to the destination node. The packets of the first sub-flow and the packets of the second sub-flow have the same 5-tuple.

The method of some embodiments further includes determining that the first sub-flow includes a response to a particular data request, where the set of parameters for aggregating is based at least partly on a size of the requested data. The set of packets may include a content length identifier, in some embodiments. The method of such embodiments further includes identifying the size of the requested data based on the content length identifier. The particular data request is an HTTP get request and the method, in some embodiments further includes identifying the size of the requested data based on data payloads of an outgoing set of packets including at least one packet that includes the HTTP get request. The method of some embodiments further includes determining that the set of packets includes data packets associated with a particular application, where the set of parameters for aggregating is based at least partly on the particular application.

The identified set of attributes, in some embodiments, includes feedback of at least one of L3, L4, and L7 layers of the data flow. The feedback from the L3/L4 layers, in some embodiments, includes a window size of the data flow. The feedback from the L7 layers includes a URL of the data flow, in some embodiments. The set of parameters for aggregating packets of each group, in some embodiments, includes a minimum number of packets to aggregate in each group.

In some embodiments, the method further includes receiving a second set of packets, where the second set of packets includes a combined data payload size below a particular threshold. The method of such embodiments provides the second set of packets to a second destination node without aggregating the second set of packets. In some embodiments, the set of parameters for aggregating each group of packets includes an aggregation time limit for receiving a group of packets for aggregation.

The method of some embodiments described herein provides a dynamic/adaptive generic receive offload (GRO) operation that aggregates packets of different data flows and even groups of packets of the same data flows according to parameters that are adjusted to account for the nature of the flows/groups of packets. These dynamic/adaptive GRO operations ensure, among other advantages, that groups of packets for applications that are harmed by high latency do not overly delay the delivery of data by aggregating too many packets and that larger numbers of packets in groups of packets for applications that do not suffer from high latency are aggregated.

In some embodiments, a software defined network (SDN) implements aggregation of data packets to realize efficiencies by allowing applications to process smaller numbers of larger data packets. One of ordinary skill in the art will understand that the below described techniques could also be implemented in other networks besides SDNs (e.g., other virtual or physical networks).

As used in this document, data messages refer to a collection of bits in a particular format sent across a network. One of ordinary skill in the art will recognize that the term data message may be used herein to refer to various formatted collections of bits that may be sent across a network, such as Ethernet frames, IP packets, TCP/IP packets, TCP segments, UDP datagrams, etc. Also, as used in this document, references to L2, L3, L4, and L7 layers (or layer 2, layer 3, layer 4, layer 7) are references, respectively, to the second data link layer, the third network layer, the fourth transport layer, and the seventh application layer of the OSI (Open System Interconnection) layer model. TCP/IP packets include an addressing tuple (e.g., a 5-tuple specifying a source IP address, source port number, destination IP address, destination port address and protocol). Network traffic refers to a set of data packets sent through a network. For example, network traffic could be sent from an application operating on a machine (e.g., a virtual machine or physical computer) on a branch of an SD-WAN through a hub node of a hub cluster of the SD-WAN. As used herein, the term “data flow” refers to a set of data sent from a particular source (e.g., a machine on a network node) to a particular destination (e.g., a machine on a different network node) and, in some cases, return packets from that destination to the source. The term “sub-flow” refers to a sub-set of a larger data flow. For example, a particular data flow may be used to transfer files from one machine to another machine. One sub-flow could be a first file having a particular size (e.g., 10 MB) while a second sub-flow could be another file having a different size (e.g., 1 kB). As another example, a particular flow could be used to send different types of data with a first sub-flow being a video call and a second sub-flow being a text message. One of ordinary skill in the art will understand that the inventions described herein may be applied to packets of a particular data stream going in one direction or to packets going in both directions.

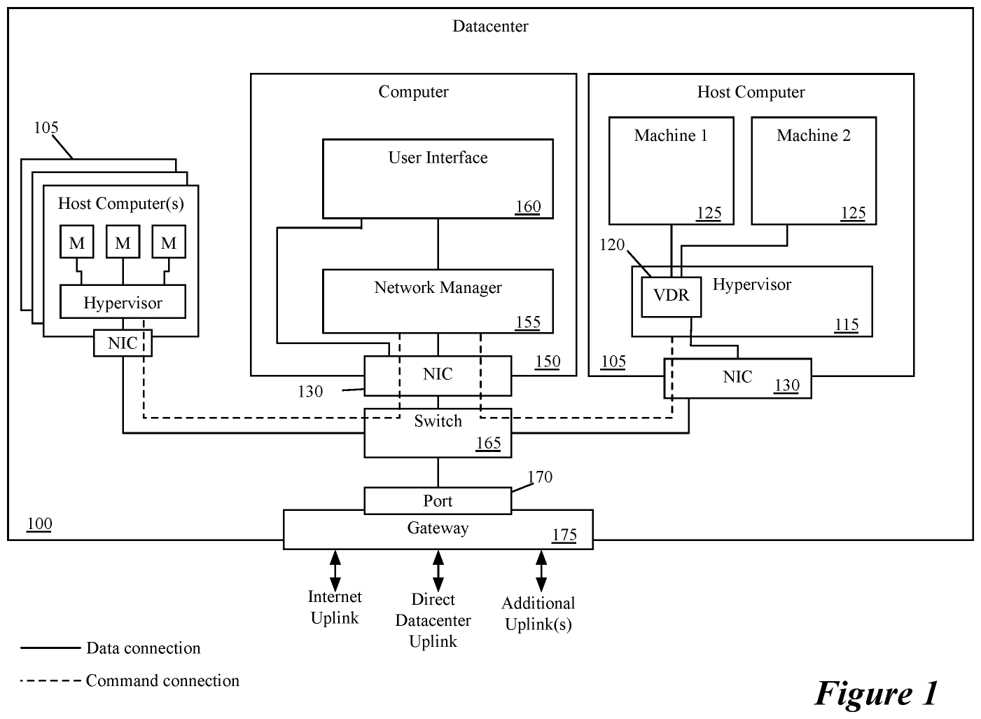

FIG. 1 illustrates a datacenter 100 of some embodiments. The datacenter 100 includes multiple host computers 105, a computer 150 that implements software for controlling the logical elements of the datacenter, and a gateway 175. Each host computer 105 includes a hypervisor 115 with a virtual distributed router 120. Each host computer 105 implements one or more machines 125 (e.g., virtual machines (VMs), containers or pods of a container network, etc.). The computer 150 may be another host computer, a server, or some other physical or virtual device in the datacenter. Computer 150 includes a network manager 155 (sometimes called a “software defined datacenter manager”) and a network user interface 160. Each computer 105 and 150 has a network interface card 130 that connects to a switch 165 (e.g., a physical or logical switch) of the datacenter 100. The switch 165 routes data messages between the computers 105 and 150 and between the computers 105 and 150 and the gateway 175 through the port 170 (e.g., a logical port) of the gateway 175. The gateway 175 then sends data messages out through one or more uplinks (e.g., an internet uplink, a direct datacenter uplink, a provider services uplink, etc.). One of ordinary skill in the art will understand that the uplinks in some embodiments are not separate physical connections, but are conceptual descriptions of different types of communications paths that data messages will pass through, given the source and destination addresses of the data messages.

Incoming data packets are received at the gateway 175, and then sent to NICs 130 of the individual host computers of the datacenter 100. The NICs 130 handle the L1/L2 layers of the network traffic and then send the data packets for routing by the VDR 120 to the destination machines 125 (e.g., to be received by applications operating on the machines).

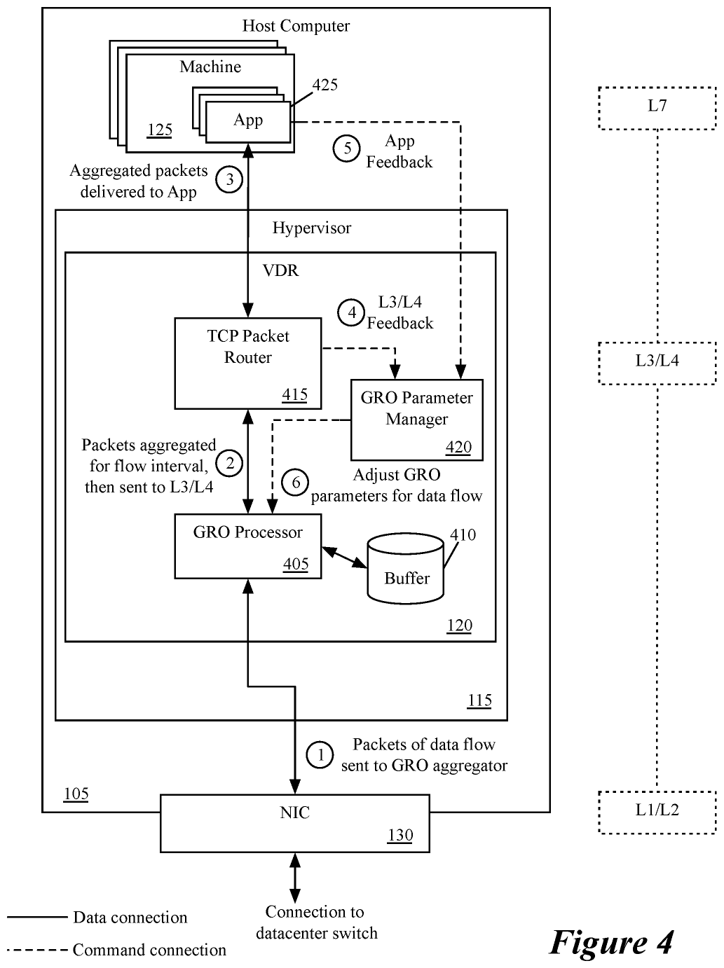

In some embodiments, before processing the L3/L4 layers of the packets to send the packets to their destination machines 125, the VDR 120 implements a GRO layer to consolidate the packets into a smaller number of packets with larger data payloads. More details about the GRO layer of the VDR 120 are described with respect to FIG. 4, below.

The hypervisor 115 is computer software, firmware or hardware operating on a host computer 105 that creates and runs machines 125 on the host (e.g., virtual machines, containers, pods, etc.). In the embodiment of FIG. 1, the hypervisor 115 includes a VDR 120 that routes data messages between machines 125 within the host computer 105 and between the machines 125 and the NIC 130 of the host computer 105. The hypervisors 115 and VDRs 120 of some embodiments of the invention are configured by commands from a network manager 155.

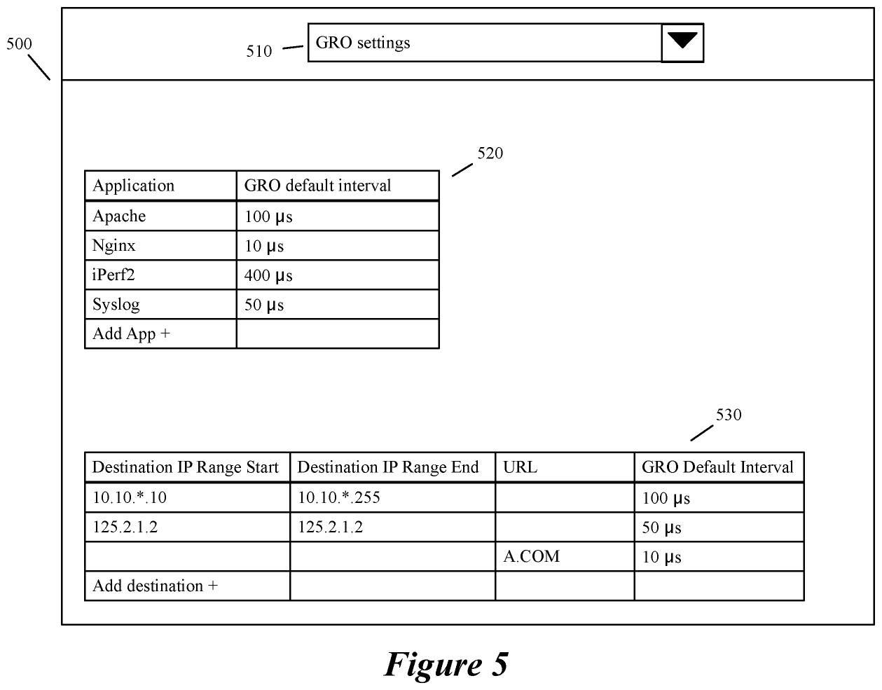

The network manager 155 provides commands to network components of the datacenter 100 to implement logical operations of the datacenter (e.g., implement machines on the host computers, change settings on hypervisors, etc.). The network manager 155 receives instructions from the network user interface 160 that provides a graphical user interface (GUI) to an administrator of the datacenter 100 and receives commands and/or data input from the datacenter administrator. In some embodiments, this GUI is provided through a web browser used by a datacenter administrator (e.g., at a separate location from the datacenter 100). In other embodiments, a dedicated application at the administrator's location displays data received from the network user interface 160, receives the administrator's commands/data, and sends the commands/data through the GUI to the network manager 155 through the network user interface 160. Such a GUI will be further described below with respect to FIG. 5, below.

The received commands in some embodiments include commands to the VDRs 120 of FIG. 1, to adjust GRO layer time intervals for flows of various applications. The VDRs 120 of some embodiments may send feedback to the network manager 155 to quantify the performance of the GRO layer. In FIG. 1, the command connections are illustrated separately from the data connections for clarity, but one of ordinary skill in the art will understand that the command messages may be sent, part way or entirely, on communications routes (e.g., physical or virtual connections) that are used by data messages.

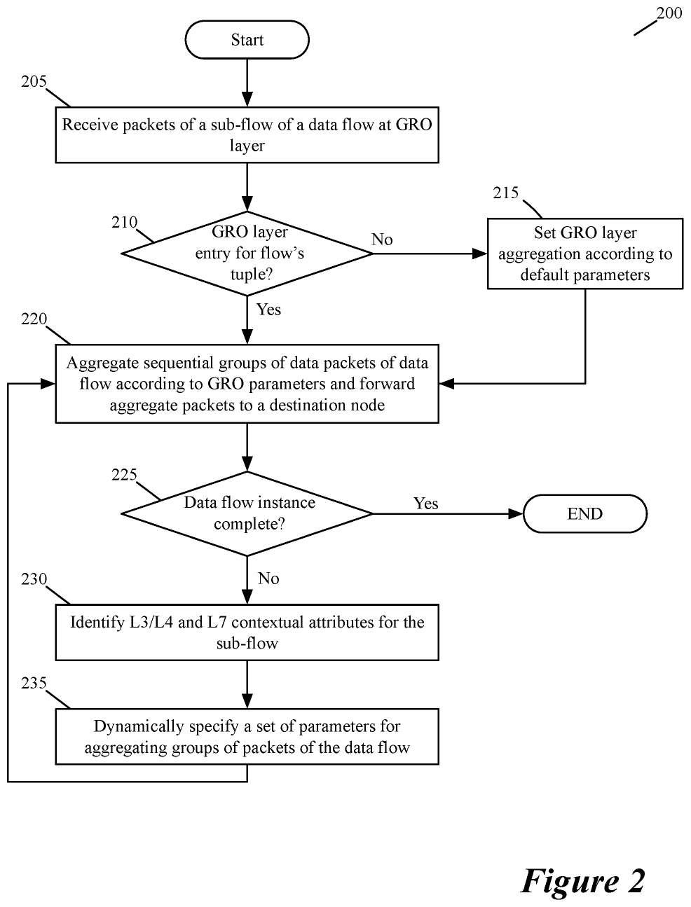

FIG. 2 conceptually illustrates a process 200 of some embodiments aggregating data packets at a GRO layer and forwarding the aggregated packets. The process receives (at 205) packets of a sub-flow of a data flow at the GRO layer. The process then determines (at 210) whether there is a GRO layer entry (e.g., in a table of tuples and associated parameters for aggregating parameters) associated with the tuple of the sub-flow. In some embodiments, the parameter is a specified time interval (sometimes called a GRO flush timeout) to wait for packets of a flow while aggregating sequential packets. When the process 200 determines that there is not a GRO layer entry for the sub-flow at the GRO layer, the process sets (at 215) the GRO layer parameter for that tuple to a default parameter (e.g., aggregate packets for 10 μs before forwarding the resulting aggregated packet on).

When there is a GRO layer entry, or using the default interval, the process 200 then aggregates (at 220) sequential groups of data packets according to the GRO parameters and forwards the aggregated packets to a destination node. The destination node in some embodiments can be any of a destination machine (e.g., a VM, a container of a container network, a pod on which one or more containers execute, an application executed by any of the previous elements, etc.), an application (e.g., a middlebox or endpoint application), back end server, etc. In some embodiments, the backend servers (1) can be middlebox service machines, nodes or appliances that process data packets on their way to their end destination compute nodes, or (2) can be the end destination compute nodes for the packets.

In some embodiments, the GRO parameters may be the previously described time interval. For example, if the time interval for a first tuple is 50 μs, the GRO layer would aggregate the data payloads of all data packets received in a 50 microsecond interval that are sequential. As used herein, “sequential data packets” are a set of packets within a particular data flow that are not missing any packets. Thus the payloads of a set of sequential packets represent a contiguous subsection of the data that had been broken into packets for transmission over the network. The aggregated packet payload data is then provided a header corresponding to the headers of that group of sequential packets. A corresponding header, in some embodiments, includes the same tuple as the packets in the group of sequential packets and in some embodiments the same header values. In some embodiments, the headers include modified entries reflecting the larger amount of data (e.g., a different packet sequence value from most of the group of sequential packets). After each 50 microsecond interval, the GRO layer would begin aggregating the next group of sequential packets of that flow for the next 50 μs and so on.

In some embodiments, while performing the aggregations, the process 200 would periodically (or with an interrupt, etc.) determine (at 225) whether the sub-flow was complete. In some embodiments, this could be when the process receives a “transmission complete” packet, when an expected number of bytes has been received, or after a threshold period without any packets being received. If the sub-flow is complete, the process 200 ends, for that sub-flow. One of ordinary skill in the art will understand that multiple sub-flows for different data flows may be occurring in parallel in some embodiments and that subsequent sub-flows of the same data flow result in the process 200 restarting for the new sub-flow.

The parameters of the aggregation operation are then modified, in some embodiments by the following feedback/adjustment operations. The process 200 identifies (at 230) a set of one or more attributes associated with a set of one or more packets of the data flow. In some embodiments, these attributes are identified from contextual feedback from the L3/L4 and L7 layers. Contextual feedback for the L3/L4 layers, in some embodiments, is based on an inline flow analysis that provides hints (of what parameters, such as timeout interval, are appropriate for a sub-flow) based on several L3/L4 parameters such as the round trip time (RTT), window size, maximum segment size (MSS), etc. Similarly the contextual feedback for the L7 layer for a particular request could provide hints based on the request type such as GET/100 MB (which would indicate that a relatively longer interval was more efficient for that sub-flow) or GET/64B (which would indicate that skipping the GRO layer would be most efficient as the requested file would fit in one packet). Some embodiments identify other attributes such as application ID, a deep packet inspection (DPI) AppID, traffic flow ID, a virtual service of the sub-flow identified based on the app type (L4/L7 app), a URL of the sub-flow, http and/or TCP parameters of the sub-flow, etc.

Based on the identified set of attributes, the process 200 then dynamically specifies (at 235) a set of parameters for aggregating, for the destination node, payloads of a plurality of groups of packets of the data flow. The process 200 then returns to operation 220 to aggregate later packets according to the new set of parameters.

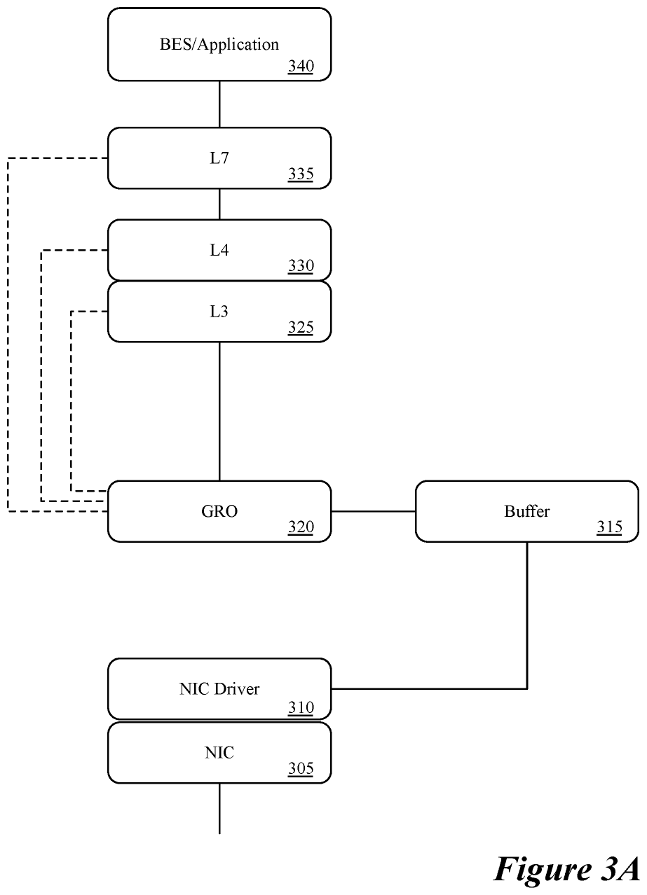

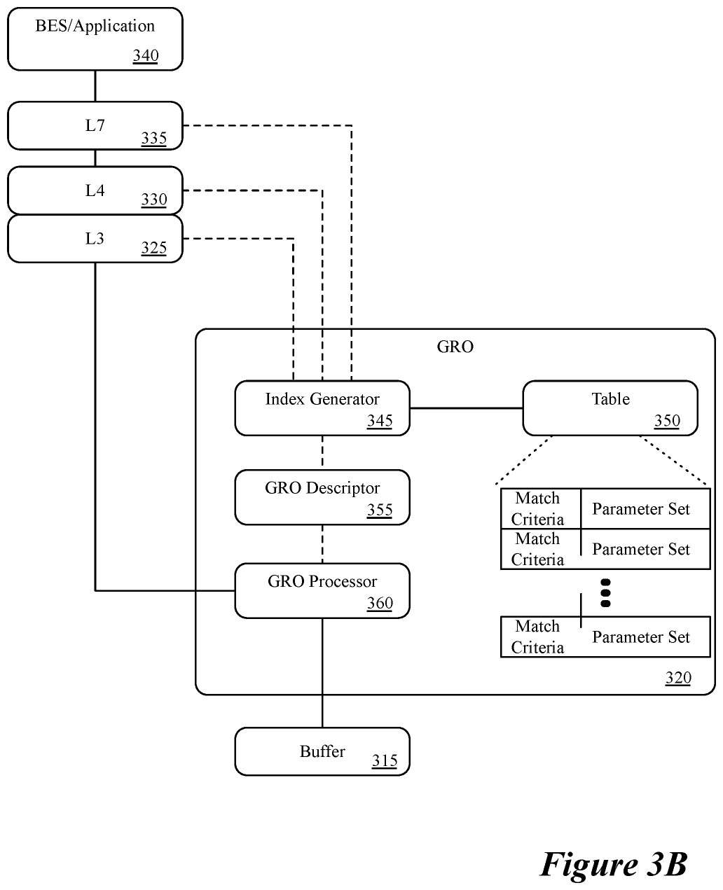

FIG. 3A conceptually illustrates the path of data packets and feedback through multiple protocol layers in the GRO system of some embodiments. Ethernet packets are generally received at a physical NIC 305 of a physical computer before the operations of the present invention are performed. Data packets are stored in some type of buffer 315, and provided to one or more applications on a back end server (BES) 340, e.g., software on a host computer operating as a BES, a standalone computer acting as a BES, etc. The intermediate elements of FIG. 3A are conceptual representations of the GRO operation 320 and protocol layer processors for the L3 325, L4 330, and L7 335 layers of standard OSI data packets. Specific software and/or hardware elements that perform the GRO operation 320 and the protocol layer processors 325-335, in some embodiments, are further described with respect to FIG. 4, below.

The NIC 305, of FIG. 3A, receives raw data packets (e.g., over a network such as the Internet) which are then processed by the NIC driver 310 and passed to a buffer 315. The raw packets are stored in buffer 315 and the data payloads of the packets are aggregated in a GRO operation 320. The GRO operation 320 passes the aggregated packets through other protocol layer processors 325-335 to the BES/Application 340. While processing the aggregate packets, the protocol layer processors 325-335 sends feedback to the GRO operation 320 which dynamically adjusts the parameters used to aggregate later arriving packets, before passing those packets in turn to the BES/Application 340. Although FIG. 3A shows the path of data packets passing from the NIC driver 310 to the buffer 315, in other embodiments, the packets are passed from the NIC driver 310 to a software or hardware element implementing the GRO operations 320 and that element stores the packets in a buffer while aggregating the data payloads of the packets.

FIG. 3B conceptually illustrates a more detailed view of the operations of the GRO operation 320. FIG. 3B includes an index generator 345, a table 350, a GRO descriptor 355, and a GRO processor 360. The index generator 345 receives feedback, which includes attributes of a flow, from the L3 layer processor 325, the L4 layer processor 330, and the L7 layer processor 335. The L3 and L4 processors 325 and 330 provide feedback attributes for the network and transport layers of the data flow, e.g., round trip time (RTT), window size, maximum segment size (MSS) of the data flow, etc. The L7 layer processor 335 provides feedback for the application layer of the data flow, e.g., an application ID, a deep packet inspection (DPI) AppID, traffic flow ID. In some embodiments, the index generator 345 may identify an application type, e.g., middlebox application, banking application, communication application, etc. based on the feedback. The index generator 345 compares the attributes received in the feedback to the match criteria in table 350. The matching criteria identify a set of parameters that can be then be used by the GRO descriptor 355 to define a description for the GRO aggregation.

In some embodiments, the GRO descriptor 355 generates, from the parameter set retrieved from the table 350 for a particular sub-flow, a description of the GRO operation that the GRO processor 360 has to perform for the particular sub-flow. This description in some embodiments includes the flush timeout value of the GRO operation, and it is computed by using the retrieved parameter set (e.g., when the retrieved parameter set includes multiple timeout periods, by adding the multiple timeout periods retrieved from table 350 for the particular sub-flow). The equations below provide an example of a calculation the GRO descriptor 355 uses in some embodiments to identify a flush timeout value for a sub-flow.

$${T}_{c u r r} = {\sum }_{i = 0}^{n} f ( {w}_{i} {x}_{i} )$$

$$EWMA ( {T}_{flow ( t )} ) = a * {T}_{c u r r} + ( 1 - α ) * E W M A ( {T}_{flow ( t - 1 )} )$$

Where, x∈{src ip, RTT, window size, MSS, Application, etc.}, wᵢ is the weight associated with each of the parameters, and EWMA is an exponential weighted moving average. In the example equations, not all of the attributes are numerical, such as “Application.” Similarly, some quantities that are numerical are identifier values rather than quantities, for example, “src IP” is the source IP. Such values are not used directly in mathematical calculations. Accordingly, in this example, the index generator 345 uses the match criteria to produce quantitative values f(wᵢxᵢ) as the parameters to supply to the GRO descriptor 355. However, other embodiments use other equations and/or other parameters in their parameter sets. In some embodiments, these parameters may include non-numerical or non-quantitative parameters which the GRO descriptor 355 would then evaluate in some non-mathematical procedure. The GRO descriptor 355 then supplies the description to the GRO processor 360. The GRO processor 360 would then aggregate later received packets according to the description generated by the GRO descriptor 355.

The above described embodiment uses a flush timeout value as the description for the GRO processor 360 to use. However, in other embodiments, rather than using a flush timeout value, other descriptions are used to determine how to aggregate packets, such as a description that specifies a minimum number of packets to aggregate for a particular application, the minimum number of packets to aggregate during a maximum or minimum timeout period, etc. Additionally, although the above described embodiment includes a GRO processor 360 that performs according to descriptions that affect particular flows, in some embodiments, the GRO processor 360 may receive descriptions on a per sub-flow, a per application, or per URL basis. That is, in some embodiments, the GRO processor 360 may receive a separate description for each sub-flow, or each URL, with the GRO processor 360 tracking which sub-flow or URL is being received. Similarly, the GRO processor 360 of some embodiments may receive a separate description for each application, such as timeouts of 100 μs for Apache, 10 μs for Nginx, 400 μs for iPerf2, and 50 μs for Syslog, with the GRO processor 360 tracking which application a flow is associated with.

FIG. 4 illustrates the operations of the virtual distributed router 120 to implement the GRO layer between the NIC 130 and the machines of a host computer 105. As used in FIG. 1, solid lines of communication between elements in FIG. 4 represent data packets being sent, while dashed lines indicate commands and control data (e.g., feedback) being sent. The dotted lines showing the L1, L2, L3, L4, and L7 are shown at the level within the figure of the handler of each protocol layer. FIG. 4 includes a more detailed view of the VDR 120, which includes a GRO processor 405, a buffer 410, a TCP packet router 415, and a GRO parameter manager 420 that incorporates the features described with respect to FIG. 3B as being performed by an index generator 345, table 350, and GRO descriptor 355. Additionally, FIG. 4 shows more details of machine 125 including an application 425.

The NIC 130 receives packets of a dataflow from outside of the host machine. Multiple operations affect the following aggregation of the packets. First, the packets are sent from the NIC, which handles the L1/L2 layer of the OSI network aspects of the packets. Second, the GRO processor 405 aggregates sequential packets over a time interval determined by the flow and sends the aggregated packets to the TCP packet router 415 that handles the L3/L4 layer of the packets (e.g., routing the TCP/IP packets to the IP address of the destination machine 125 with the destination TCP port number identified so that the machine 125 can distinguish between separate data flows). The GRO processor 405 of some embodiments maintains a table (or other associational data structure) associating tuples of received data flows with a particular time interval. In some embodiments, the tuple itself is used as the matching criterion, but in other embodiments, the GRO processor 405 applies more matching criteria such as the application and/or URL associated with a sub-flow, expected size of the sub-flow, etc. The GRO processor 405 of some embodiments stores the received data packets in buffer 410 while it is aggregating them.

Third, the machine 125 provides the aggregated packets to the application 425. The application 425 could be any type of application including applications that handle the L7 layer of the packets or applications that handle additional operations on the L3/L4 layer. For example, application 425 could be a load balancing application, firewall, encryption/decryption application, banking application, VOIP or other communication application, etc. Some specific applications that benefit from the present invention include NGINX, iPerf2, Apache, and Syslog.

While the application 425 handles the aggregated packets, in the fourth GRO related operation the GRO parameter manager 420 receives feedback from the TCP packet router 415. This feedback may include average RTT times for the packets, average sub-flow sizes, etc. In some embodiments, as a fifth operation, the GRO parameter manager 420 receives application feedback from the application 425. In other embodiments, the L7 feedback may be provided by some other component than directly from the application, e.g., a DPI implemented by the VDR 120 that analyzes the L7 layer of the packets or an agent operating on the host that monitors the application 425, etc. Sixth, the GRO parameter manager 420 determines a proper GRO time interval and provides it to the GRO processor 405. In some embodiments, the new time intervals are determined on a per application, per flow, or per URL basis with the GRO processor 405 determining the application, or URL of each particular sub-flow. In other embodiments, the GRO processor 405 maintains one time interval associated with each tuple and the time interval for any given tuple is adjusted by the GRO parameter manager 420 as new feedback is received for that tuple.

The aggregation of the packets has several advantages. First, for cryptographic applications, the application can operate on larger blocks of data, improving efficiency. Second, the aggregated packets reduce processing work at each layer of the network stack, as the components (e.g., TCP router and application) that handle each protocol layer above L2 no longer have to perform a flow table look-up operation for each approximately 1450 bytes of payload data, but rather perform a flow table look up for each larger packet (e.g., 5 kB, etc.). Flow table look-ups are one of the most computationally expensive operations any stateful appliance performs. Therefore aggregation produces great efficiency gains from that.

Third, for middlebox applications that perform analysis or processing of the packets, the processed packets may then be sent to other application on the host computer 105 or other host computers of the datacenter. The aggregation may yield additional efficiency bonuses for the outbound packets, especially if the packets are processed by multiple applications (e.g., a load balancer followed by a decryption application followed by a firewall). Typically, the MTU for packets sent within a datacenter is larger than for packets sent outside, so the packet aggregation in some embodiments may reduce later processing on other host machines 105 of the data center to which processed packets are sent (e.g., through the NIC 130 or other NICs on the host 105 or other hosts) after the application 425 is done with them.

In the embodiments illustrated by FIG. 4, the GRO parameter manager 420 receives feedback relating to the L3/L4 and L7 layers, in other embodiments, the GRO parameter manager 420 receives feedback relating to other layers such as the L2, L5, and/or L6 layers. The elements of FIG. 4 are one possible arrangement of elements to implement the methods of the present invention. However, other embodiments may combine or divide operations of the described elements differently. For example, in some embodiments, the GRO parameter manager 420 may be integrated with the GRO processor 405, etc. Furthermore, one of ordinary skill in the art will understand that in some embodiments, the buffer 410 may be used to store other data in addition to the incoming packets being aggregated such as feedback data used by the GRO parameter manager 420, etc.

Although in some embodiments the default values for the GRO settings are provided in the software that implements the SDN, in other embodiments, the SDN network manager provides a network user interface that allows a network administrator to set default values and/or rules for GRO aggregation. FIG. 5 illustrates a graphical user interface (GUI) 500 for setting default GRO intervals. One of ordinary skill in the art will understand that this is an example of GUIs of some embodiments and that in other embodiments other controls and options are provided. The GUI 500 includes a pulldown menu 510 for selecting the GRO settings from among other network controls, an application GRO default interval table 520, and a destination GRO default interval table 530. The application GRO default interval table 520 allows a network administrator to set initial default intervals for the various applications operating on the host. The table 520 also allows an administrator to add additional applications to the set of applications with a default value. Similarly, the destination GRO default interval table 530 allows a network administrator to select a range of destination IP addresses and URLs, set a default GRO interval for the destinations IPs or URLs and add additional destinations.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, are non-VM DCNs that include a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

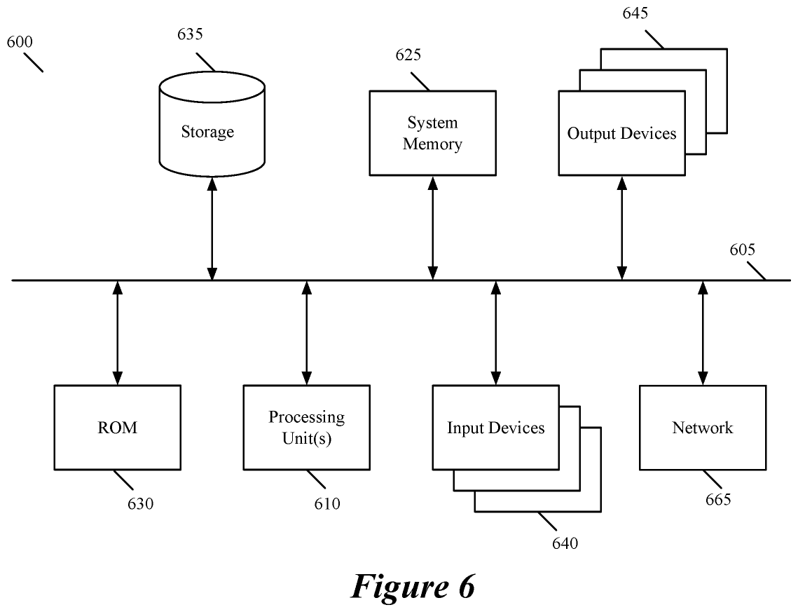

FIG. 6 conceptually illustrates a computer system 600 with which some embodiments of the invention are implemented. The computer system 600 can be used to implement any of the above-described hosts, controllers, gateway and edge forwarding elements. As such, it can be used to execute any of the above-described processes. This computer system 600 includes various types of non-transitory machine-readable media and interfaces for various other types of machine-readable media. Computer system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the computer system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments. The read-only-memory (ROM) 630 stores static data and instructions that are needed by the processing unit(s) 610 and other modules of the computer system. The permanent storage device 635, on the other hand, is a read-and-write memory device. This device is a non-volatile memory unit that stores instructions and data even when the computer system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device 635. Like the permanent storage device 635, the system memory 625 is a read-and-write memory device. However, unlike storage device 635, the system memory 625 is a volatile read-and-write memory, such as random access memory. The system memory 625 stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices 640 enable the user to communicate information and select commands to the computer system 600. The input devices 640 include alphanumeric keyboards and pointing devices (also called “cursor control devices”). The output devices 645 display images generated by the computer system 600. The output devices 645 include printers and display devices, such as cathode ray tubes (CRT) or liquid crystal displays (LCD). Some embodiments include devices such as touchscreens that function as both input and output devices 640 and 645.

Finally, as shown in FIG. 6, bus 605 also couples computer system 600 to a network 665 through a network adapter (not shown). In this manner, the computer 600 can be a part of a network of computers (such as a local area network (“LAN”), a wide area network (“WAN”), or an Intranet), or a network of networks (such as the Internet). Any or all components of computer system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments deploy gateways in public cloud datacenters. However, in other embodiments, the gateways are deployed in a third-party's private cloud datacenters (e.g., datacenters that the third-party uses to deploy cloud gateways for different entities in order to deploy virtual networks for these entities). Thus, one of ordinary skill in the art would understand that the invention is not to be limited by the foregoing illustrative details, but rather is to be defined by the appended claims.

1. A method of forwarding packets to a destination node executing on a host computer, the method comprising:
identifying a set of one or more attributes associated with a set of one or more packets of a data flow;
based on the identified set of attributes, dynamically specifying a set of parameters for aggregating, for the destination node, payloads of a plurality of groups of packets of the data flow;
creating, according to the set of parameters, an aggregate packet for each group of packets; and
forwarding each aggregate packet to the destination node.

2. The method of claim 1, wherein aggregating each group of packets comprises setting headers for each aggregate packet, forwarded to the destination node, wherein the headers for each aggregate packet correspond to headers of the group of packets.

3. The method of claim 1, wherein the set of packets comprises packets that belong to a first sub-flow of the data flow.

4. The method of claim 3, wherein the first sub-flow comprises packets of the flow differentiated from other sub-flows of the data flow by L7 parameters of the sub-flow.

5. The method of claim 4, wherein the set of packets is a first set of packets, the set of attributes is a first set of attributes, and the set of parameters is a first set of parameters, the method further comprising:
identifying a second set of one or more attributes of a second set of packets of the data flow, the second set of packets comprising a second sub-flow;
based on the identified second set of attributes, dynamically specifying a second set of parameters for aggregating, for the destination node, payloads of a plurality of groups of packets of the second sub-flow of the data flow, wherein the second set of parameters are different from the first set of parameters; and
forwards an aggregate packet for each group of packets of the second sub-flow to the destination node.

6. The method of claim 5, wherein the packets of the first sub-flow and the packets of the second sub-flow comprise packets that have the same 5-tuple.

7. The method of claim 4 further comprising determining that the first sub-flow comprises a response to a particular data request, wherein the set of parameters for aggregating is based at least partly on a size of the requested data.

8. The method of claim 7, wherein the set of packets comprises a content length identifier, the method further comprising identifying the size of the requested data based on the content length identifier.

9. The method of claim 7, wherein the particular data request is an HTTP get request, the method further comprising identifying the size of the requested data based on data payloads of an outgoing set of packets comprising at least one packet that includes the HTTP get request.

10. The method of claim 4 further comprising determining that the set of packets comprises data packets associated with a particular application, wherein the set of parameters for aggregating is based at least partly on the particular application.

11. The method of claim 1, wherein the identified set of attributes comprises feedback of at least one of L3, L4, and L7 layers of the data flow.

12. The method of claim 11, wherein feedback from the L3/L4 layers comprises a window size of the data flow.

13. The method of claim 11, wherein feedback from the L7 layers comprises a URL of the data flow.

14. The method of claim 1, wherein the set of parameters for aggregating packets of each group comprises a minimum number of packets to aggregate in each group.

15. The method of claim 1, wherein the set of packets is a first set of packets, and the destination node is a first destination node, the method further comprising:
receiving a second set of packets, wherein the second set of packets comprises a combined data payload size below a particular threshold; and
providing the second set of packets to a second destination node without aggregating the second set of packets.

16. The method of claim 1, wherein the set of parameters for aggregating each group of packets comprises an aggregation time limit for receiving a group of packets for aggregation.

17. A non-transitory machine readable medium storing a program which when executed by at least one processing unit forwards packets to a destination node executing on a host computer, the program comprising sets of instructions for:
identifying a set of one or more attributes associated with a set of one or more packets of a data flow;
based on the identified set of attributes, dynamically specifying a set of parameters for aggregating, for the destination node, payloads of a plurality of groups of packets of the data flow;
creating, according to the set of parameters, an aggregate packet for each group of packets; and
forwarding each aggregate packet to the destination node.

18. The non-transitory machine readable medium of claim 17, wherein the set of instructions for aggregating each group of packets comprises a set of instructions for setting headers for each aggregate packet, forwarded to the destination node, wherein the headers for each aggregate packet correspond to headers of the group of packets.

19. The non-transitory machine readable medium of claim 17, wherein the set of packets comprises packets that belong to a first sub-flow of the data flow.

20. The non-transitory machine readable medium of claim 19, wherein the first sub-flow comprises packets of the flow differentiated from other sub-flows of the data flow by L7 parameters of the sub-flow.
